(19) United States
(12) Patent Application Publication
(10) Pub. No.: US 2019/0267224 A1
(43) Pub. Date: Aug. 29, 2019

(54) INTERFACE DEVICE

(71) Applicant: The University of Tokyo, Tokyo (JP)

(72) Inventors: Takehiko Kitamori, Tokyo (JP); Kazuma Mawatari, Tokyo (JP); Yutaka Kazoe, Tokyo (JP)

(21) Appl. No.: 16/336,062

(22) PCT Filed: Sep. 12, 2017
(86) PCT No.: PCT/JP2017/032820

§ 371 Date: Mar. 22, 2019

(30) Foreign Application Priority Data
Sep. 23, 2016 (JP) 2016-185088

(51) Int. Cl. H01J 49/04

(52) U.S. Cl. CPC H01J 49/0459; H01J 49/0468

(57) ABSTRACT

The present disclosure provides an interface device that is capable of introducing a sample that has been ionized into a mass spectrometer with high efficiency. An ice droplet generating section forms ice droplets from a liquid sample that has been supplied from a sample supply section. Further, the ice droplet generating section successively introduces the formed ice droplets into an ionization section. The ionization section ionizes the sample that has been made into ice droplets, and conveys these ionized droplets into a mass spectrometer.

### BACKGROUND

### Technical Field

The present disclosure relates to an interface device for introducing a sample into a mass spectrometer.

### Description of the Related Art

Mass spectrometry is known as a method for identifying and quantifying a substance. In mass spectrometry, it is possible to identify and quantify a substance by converting the substance (sample) into minute ions (hereafter sometimes abbreviated to “sample ions”) at the atomic or molecular level using various ionization methods, and measuring the mass number and number of those ions. This method is an important analysis method frequently used in the fields of organic chemistry and biochemistry.

Regarding this analysis method, in order to introduce a sample into a mass spectrometer and perform measurement, there are known, for example:
a method of introducing the sample directly into the mass spectrometer and performing measurement, and
a method of introducing desired components that have been separated by chromatography or capillary electrophoresis, etc., into the mass spectrometer and performing measurement.

However, in the case of using a mass spectrometer, after having extracted target components within a sample into a gaseous phase as ions, those ions are detected under a high vacuum. This means that in analysis of a gas sample, while analysis is simpler if a gas sample is introduced as is into the mass spectrometer, analysis of a liquid sample was difficult. In recent years, therefore, an atmospheric pressure ionization method has been implemented that involves spraying a liquid sample at atmospheric pressure in an interface, ionizing by vaporizing a solvent in a process where fine liquid drops are displaced, and introducing sample ions (target components) into a high vacuum of a mass spectrometer, and this method has been widely used in mass spectrometry. As examples among atmospheric pressure ionization methods, there are an electrospray method and an atmospheric chemical ionization method. However, with these methods since only some of a liquid sample that has been sprayed is introduced into the mass spectrometer, a final rate of sample introduction into the mass spectrometer is about 1%, and there is a problem in that analysis of a low concentration sample is difficult.

With regard to this problem, technology has been proposed, in patent publication 1 below, to generate a rod like solid (namely rodlike lumps of ice) by cooling a liquid sample at a tip of a capillary tube for sample insertion, and introducing this solid into a vacuum of a mass spectrometer.

However, with this technology, since rodlike lumps of ice are conveyed using a capillary tube, movement resistance is large and it is to be expected that conveyance will be difficult. Also, in the case of ionizing lumps of ice that have been formed continuously and in large size, and introducing them into a mass spectrometer, it can be expected that the efficiency of introducing sample ions into the mass spectrometer will not be significantly different to that with an atmospheric ionization method.

### CITATION LIST

### Patent Literature

[Patent Publication 1] Japanese patent laid-open publication No. Hei 8-211020 (paragraph 0015 and FIG. 2).

### BRIEF SUMMARY

The present disclosure has been conceived based on the previously described knowledge. The present disclosure provides an interface device that is capable of introducing a sample that has been ionized into a mass spectrometer with high efficiency.

Devices and methods for solving the above described problem can be described as in the following aspects.

(Aspect 1)

An interface device for introducing a sample from a sample supply section into a mass spectrometer, comprising an ice droplet generating section and an ionization section, wherein the ice droplet generating section is configured to form ice droplets from a liquid sample that has been supplied from the sample supply section, and successively convey ice droplets that have been formed into the ionization section, and the ionization section is configured to ionize the sample that has been made into ice droplets, and convey the ionized sample into the mass spectrometer.

(Aspect 2)

The interface device of aspect 1, further comprising a droplet generating section, wherein the droplet generating section is configured to generate droplets from the liquid sample that has been supplied from the sample supply section, and the ice droplet generating section is configured to form the ice droplets from the droplets that have been generated by the droplet generating section.

(Aspect 3)

The interface device of aspect 2, wherein the ice droplet generating section is configured to form ice droplets by cooling the droplets that have been conveyed towards the ionization section from the droplet generating section.

(Aspect 4)

The interface device of aspect 2 or aspect 3, further provided with a conveying section, wherein the conveying section is configured to convey the droplets that have been generated by the droplet generating section towards the ionization section, and the ice droplet generating section is configured to form the ice droplets by cooling the droplets within the conveying section.

(Aspect 5)

A mass spectrometer device comprising the interface device of aspect one, a sample supply section that supplies a liquid sample to this interface device, and a mass spectrometer for performing mass spectrometry of a sample that has been ionized by the interface device.

(Aspect 6)

A sample conveyance method for conveying a sample from a sample supply section to a mass spectrometer, comprising a step of generating ice droplets from a liquid sample that has been supplied from the sample supply section, a step of generating sample ions by sequential ionization of the ice droplets that have been generated, and a step of conveying the sample ions to the mass spectrometer.

According to the present disclosure, it is possible to introduce a sample that has been ionized into a mass spectrometer with high efficiency.

### BRIEF DESCRIPTION OF THE SEVERAL VIEWS OF THE DRAWINGS

FIG. 1 is an explanatory drawing for showing the schematic structure of a mass spectrometry device of a first embodiment of the present disclosure.

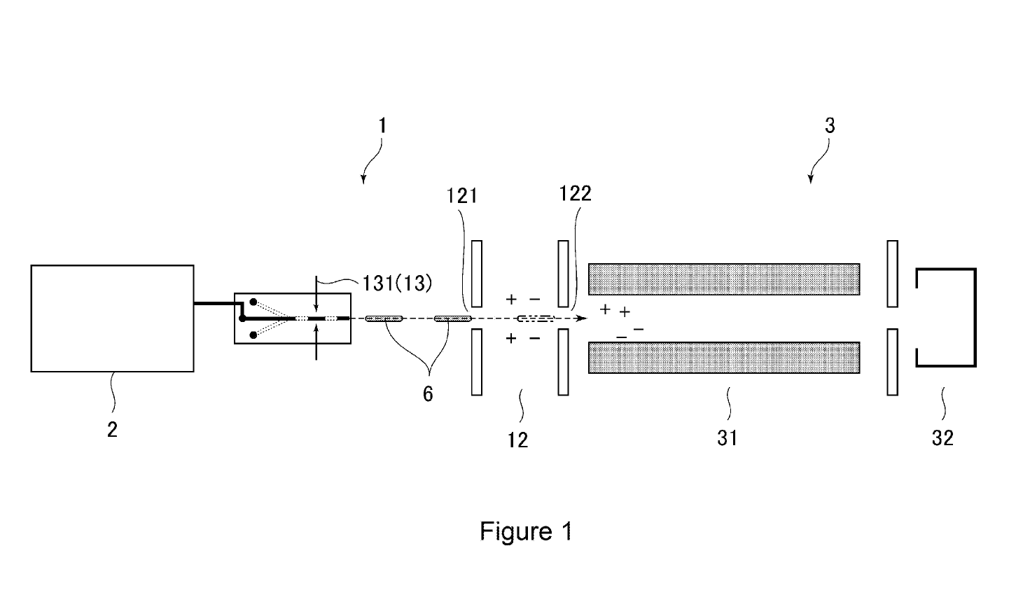

FIG. 2 is an explanatory drawing for schematically showing the structure of an interface device used in the device of FIG. 1

### DETAILED DESCRIPTION

### First Embodiment

A mass spectrometry device of a first embodiment of the present disclosure will be described in the following with reference to the attached drawings.

(Structure of the First Embodiment)

The mass spectrometry device of this embodiment comprises an interface device 1, a sample supply section 2 that supplies a liquid sample to this interface device 1, and a mass spectrometer 3 for performing mass spectrometry of a sample that has been ionized by the interface device 1, as a basic structure.

(Sample Supply Section)

As the sample supply section 2 it is possible to use, for example, a liquid sample container, or various chemical processing devices. As a chemical processing device it is possible to use, for example, a liquid chromatography, capillary electrophoresis, microfluidic device (refer to Kitamori et al., Anal. Chem., 2002, 74, 1565-1571 “Continuous-Flow Chemical Processing on a Microchip by Combining Microunit Operations and a Multiphase Flow Network”, incorporated by reference herein), or an extended-nanofluidic device (refer to Kitamori et al., Anal. Chem. 2014, 86, 4068-4077 “Extended-Nanofluidics: Fundamental Technologies, Unique Liquid Properties, and Application in Chemical and Bio Analysis Methods and Devices”, incorporated by reference herein). It should be noted that any device may be used as the sample supply section 2 as long as it is possible to continuously supply a liquid sample to the interface device 1 to a certain degree. Since it is possible to use various known devices as the sample supply section 2, more detailed description will be omitted.

(Interface Device)

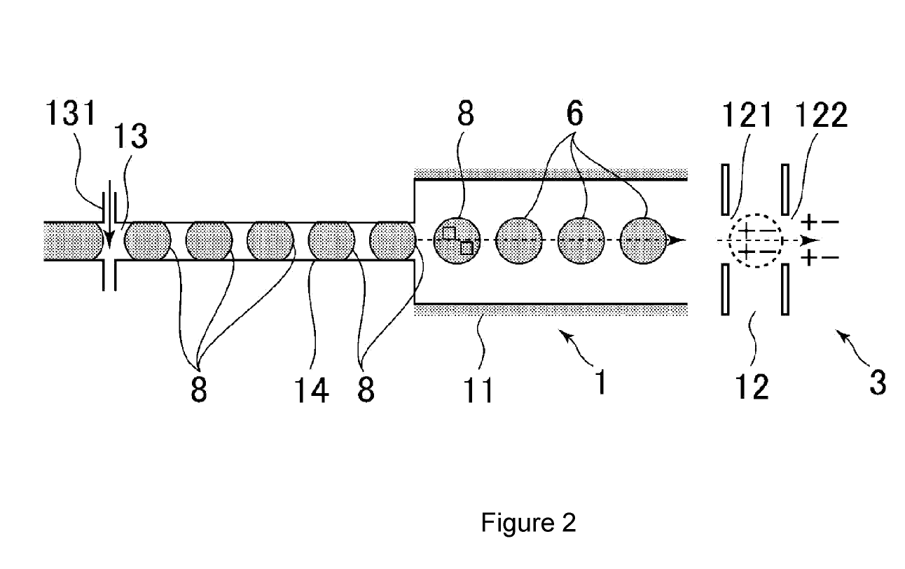

The interface device 1 is a unit for conveying a sample from the sample supply section 2 to the mass spectrometer 3, and is provided with an ice droplet generating section 11 and an ionization section 12 (refer to FIG. 2). Further, the interface device of this embodiment is also provided with a droplet generating section 13 and a conveying section 14 (refer to FIG. 2).

The ice droplet generating section 11 is configured to form ice droplets from a liquid sample that has been supplied from the sample supply section 2, and successively convey ice droplets that have been formed into the ionization section 12. More specifically, the ice droplet generating section 11 of this embodiment is configured to generate ice droplets from droplets that have been generated by the droplet generating section 13. Even more specifically, the ice droplet generating section 11 of this embodiment is capable of cooling droplets that have been conveyed towards the ionization section 12 from the droplet generating section 13, and as a result the droplets are solidified and ice droplets 6 can be formed. As this type of ice droplet generating section 11 it is possible to use various cooling means that are capable of freezing droplets instantaneously.

The ionization section 12 is configured to ionize the sample that has been made into ice droplets, and convey the ionized sample into the mass spectrometer 3. As the ionization section 12 it is possible to use a procedure for ionizing the sample using the following means, for example:
electric field application;
heating; and
method of ionization using sublimation by introducing ice droplets directly into a vacuum.

The ionization section 12 of this example is in a region where an ice droplets receiving inlet 121 and an ion convey outlet 122 have been provided. A method of ionizing a sample in the ionization section 12 is the same as that conventionally used, and so more detailed description will be omitted.

The droplet generating section 13 (refer to FIG. 2) is configured to generate droplets from a liquid sample that has been supplied from the sample supply section 2. Specifically, the droplet generating section 13 of this example is provided with an air flow supply section 131. The air flow supply section 131 cuts a fluid using air flow shearing force by blowing air onto a fluid that flows in the conveying section 14, to generate droplets 8.

The conveying section 14 is configured to convey droplets that have been generated by the droplet generating section 13 towards the ionization section 12. More specifically, the conveying section 14 is constituted by microchannels that have been formed on a substrate, and conveys droplets from the sample supply section 2 towards the ice droplet generating section 11. Also, the air flow supply section 131 of the previously described droplet generating section 13 is connected in the middle of the conveying section 14, and droplets 8 that have been formed by the air flow supply section 131 can be conveyed to a downstream side by the conveying section 14.

(Mass Spectrometer)

The mass spectrometer 3 comprises a mass separation section 31 and a detection section 32. The mass separation section 31 is an element for separation of a sample that has been ionized. Since it is possible to use various known approaches, such as magnetic field deflection type, quadrupole type, ion trap type, time-of-flight, etc., as the mass separation section 31, detailed description will be omitted. The detection section 32 can detect a sample that has been separated to acquire necessary characteristics. Since conventional approaches can also be used for the detection section 32, detailed description of this section will be omitted.

(Operation of the First Embodiment)

Next, operation of the mass spectrometry device of the first embodiment will be described.

First, a liquid sample is sent from the sample supply section 2 to the conveying section 14 of the interface device 1. The sample that has been sent reaches the droplet generating section 13 (refer to FIG. 2) and is cut using the airflow. In this way, with this embodiment, it is possible to form the droplets 8.

The droplets that have been formed progress towards a downstream side of the conveying section 14 due to the pressure of the airflow in the droplet generating section 13, while maintaining an inter-droplet distance using a gas, and are injected from an end part of the conveying section 14 (the right end in FIG. 2), in the direction of the mass spectrometer 3.

Droplets that have been injected from the end of the conveying section 14 fly through the ice droplet generating section 11. Here, the ice droplet generating section 11 freezes droplets 8 that are in flight by cooling, and in this way it is possible to generate solid ice droplets 6.

The ice droplets 6 that have been generated continue to fly along due to their inertia, and enter into the inside of the ionization section 12 from the receiving inlet 121 of the ionization section 12.

Next, a sample that is contained in the ice droplets 6 is ionized by the ionization section 12. In this way, with this embodiment, sample ions are generated. Sample ions that have been generated are sent from a feed outlet 122 of the ionization section 12 to the mass separation section 31 of the mass spectrometer 3. Here, the inside of the mass separation section 31 of this embodiment is made with a high vacuum, which means that it is possible to draw sample ions into the inside of the mass separation section 31. In the mass spectrometer 3, it is possible to acquire required characteristics (so called mass spectrum) by detecting, using the detection section 32, a sample that has been separated by the mass separation section 31. Operation of the mass spectrometer 3 is the same as a conventional operation, and so detailed description will be omitted.

With a conventional mass spectrometry device, there is a problem in that since only an extremely small amount of the sample that has been ionized is introduced into the mass spectrometer, it is difficult to analyze a sample of low concentration. Conversely, with the device of this embodiment, ice droplets are discretely generated from the sample, these ice droplets are reliably conveyed without fail to the introduction port to the mass spectrometer, and successively ionized, which means that it is possible to introduce the ions that have been generated into the mass spectrometer 3 with high efficiency (ideally, with a high efficiency of 100%). The device of this embodiment therefore has the advantage that high sensitivity mass spectrometry becomes possible, and analysis of low concentration samples also becomes possible.

Also, a sample conveying method of this embodiment can be described as a sample conveying method comprising a step of generating ice droplets from a liquid sample that has been supplied from the sample supply section 2, a step of generating sample ions by successive ionization by the ionization section 12 of the ice droplets that have been generated, and a step of conveying the sample ions into the mass spectrometer 3.

### Second Embodiment

Next, the structure of an interface device 1 of a second embodiment of the present disclosure will be described. It should be noted that in the description of this second embodiment, elements that are basically common to the device of the first embodiment described previously will use the same reference numerals to avoid a complicated description.

With the device of the previously-described first embodiment, the ice droplet generating section 11 was configured to generate ice droplets by solidifying water droplets in flight. Conversely, with the device of the second embodiment, the ice droplet generating section 11 is configured to form ice droplets by cooling droplets that are within the conveying section 14. Specifically, the ice droplet generating section 11 of the second embodiment is formed adjacent to the conveying section 14 that conveys droplets, for example, and forms ice droplets by cooling the droplets that are within the conveying section 14. Here, ice droplets 6 that have been frozen within the conveying section 14 have large frictional force with the inner surface of the conveying section 14. Therefore, with the device of the second embodiment, it is preferable that a liquid film is formed between the ice droplets 6 and the inner surface of the conveying section 14 due to momentary heating of the surface of the ice droplets 6 within the conveying section 14 to alleviate friction between the two.

With the device of the second embodiment also, it is possible to intermittently eject the ice droplets 6 towards the inside of the ionization section 12 using pneumatic pressure and other appropriate means.

Other structures and advantages of the second embodiment are the same as those of the first embodiment, and so more detailed description has been omitted.

It should be noted that the content of the present disclosure is not limited by the previously described embodiments. The present disclosure may additionally be subject to various changes to the basic structure, within a range disclosed in the scope of the patent claims.

### DESCRIPTION OF THE NUMERALS

1 Interface device
11 ice droplet generating section
12 ionization section
121 receiving inlet
122 feed outlet
13 droplet generating section
131 air flow supply section
14 conveying section
2 sample supply section
3 mass spectrometer
31 mass separation section
32 detection section
6 ice droplets
8 droplets

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An interface device for introducing a sample from a sample supply section into a mass spectrometer, comprising:
an ice droplet generating section and an ionization section, wherein
the ice droplet generating section is configured to form ice droplets from a liquid sample that has been supplied from the sample supply section, and successively convey ice droplets that have been formed into the ionization section, and
the ionization section is configured to ionize the sample that has been made into ice droplets, and convey the ionized sample into the mass spectrometer.

2. The interface device of claim 1, further comprising:
a droplet generating section, wherein
the droplet generating section is configured to generate droplets from the liquid sample that has been supplied from the sample supply section, and
the ice droplet generating section is configured to form the ice droplets from the droplets that have been generated by the droplet generating section.

3. The interface device of claim 2, wherein
the ice droplet generating section is configured to form the ice droplets by cooling the droplets that have been conveyed towards the ionization section from the droplet generating section.

4. The interface device of claim 2, further comprising:
a conveying section, wherein
the conveying section is configured to convey the droplets that have been generated by the droplet generating section towards the ionization section, and
the ice droplet generating section is configured to form the ice droplets by cooling the droplets within the conveying section.

5. A mass spectrometer device comprising the interface device of claim 1, a sample supply section that supplies a liquid sample to this interface device, and a mass spectrometer for performing mass spectrometry of a sample that has been ionized by the interface device.

6. A sample conveyance method for conveying a sample from a sample supply section to a mass spectrometer, comprising:
a step of generating ice droplets from a liquid sample that has been supplied from the sample supply section,
a step of generating sample ions by sequential ionization of the ice droplets that have been generated, and
a step of conveying the sample ions to the mass spectrometer.

7. The interface device of claim 3, further comprising:
a conveying section, wherein
the conveying section is configured to convey the droplets that have been generated by the droplet generating section towards the ionization section, and
the ice droplet generating section is configured to form the ice droplets by cooling the droplets within the conveying section.
